(19) United States
(12) Patent Application Publication
(10) Pub. No.: US 2006/0273574 A1
(43) Pub. Date: Dec. 7, 2006

(54) Combined shipping and accounting system

(76) Inventor: Samuel Herzog, Montreal (CA)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/297,616

(22) Filed: Dec. 8, 2005

Related U.S. Application Data
(60) Provisional application No. 60/634,570, filed on Dec. 9, 2004.

(51) Int. Cl. B42D 15/00

(52) U.S. Cl. 283/74

(57) ABSTRACT

The present invention comprises a system for interfacing an accounting system with various couriers' Web sites so that an electronic shipping transaction may be automatically placed. The system is preferably implemented as program code stored and executed by a processor or computer that is interfaced to the Internet. The system preferably retrieves shipping information from a database created and maintained by an existing accounting package, queries several shipping courier's Web sites to determine which site offers the lowest shipping cost, and places an electronic shipping order with the selected courier's Web site.

### CROSS REFERENCE TO RELATED APPLICATIONS

This application claims the benefit under 35 U.S.C. § 119(e) of copending U.S. Provisional Patent Application Ser. No. 60/634,570, filed on Dec. 9, 2004, which is incorporated by reference herein.

### FIELD OF THE INVENTION

The present invention relates to the field of information and transaction processing on the Internet. In particular, the present invention relates to an Internet-based shipping module that interfaces to a database shared with and maintained by an accounting system.

### BACKGROUND OF THE INVENTION

A typical shipping process entails numerous steps such as “pick & pack,” courier price research, invoice generation, shipment sticker printing, invoicing and shipment sticker matching, to name a few.

Step 1: Pick & Pack: A packer who is responsibile for preparing goods for shipment picks up the goods ordered, listed on a packing slip. The packer weighs each box packed for the order and provides the weight of each box, typically written on the packing slip.

Step 2: Research of the Lowest Price Courier: A person responsible for researching the most accurate and lowest price for the shipment visits at least four different courier companies for the lowest price. This person logs onto the computer system of each courier and enters the ship to, bill to and weight information. Thereafter, the courier system provides the price of the shipment. The researcher writes the price on the appropriate packing slip.

Step 3: Entering and Printing the Invoice: A person in charge of printing the invoice enters the information written on the packing slip into appropriate fields in the accounting software.

Step 4: Printing the Shipment Stickers: From the printed invoice, a person (typically the researcher described in step 2) re-enters the information from the invoice (invoice number, total COD amount, etc.) and re-enter the shipping information (each box weight, etc. . . . ) to enable the printing of the correct shipping stickers.

Step 5: Matching Invoice and Stickers: A person gathers the invoices and the shipping stickers, matches the invoice with the corresponding shipping stickers and boxes and prepares the boxes so that they are ready for pickup by the courier.

These steps require a large amount of man-power and time. In addition, because of the many steps required, there are many opportunities for mistakes to be made. Accordingly, there is a need to reduce the chance of generating errors by reducing the amount of human interaction in the shipping order placement/invoice generation process. Thus there is a need for an automated shipping/invoice generation system that saves time and diminishes the opportunity for mistakes.

### BRIEF SUMMARY OF THE INVENTION

The present invention operates by embedding the shipping system software behind the accounting software, and having both systems access and update a shared database. Because the shipping system software and the accounting system software share a database, information input into the database through either system is up-to-date in both systems. Accordingly, data needs to be entered only once through one of the systems.

As a result, when a shipper is posting an invoice, the system of the present invention will provide the shipper everything needed to carry out the shipment (i.e., the shipping stickers as well as an invoice).

The present invention significantly reduces the number of steps required to produce all of the shipment and billing information. Typically, only two persons will be needed to efficiently operate the system of the present invention: one to do the packing; and one to enter boxes in the computer system and to produce the invoice and shipping stickers.

Additionally, the present invention reduces the time required to produce the requisite shipment information (i.e., stickers, invoices, credit card slips, etc.) and thus the cost of shipping; increases customer satisfaction because of the ability to reduce the chances of incorrect information being input into the system as well as the occurrence of incorrect payments; reduces shipping delays; and provides the ability to track a shipment.

The present invention also reduces the amount of time spent on the phone with a Customer Service Representative because customers receive up-to-date tracking information via a tracking hyperlink forwarded through e-mail.

The present invention can also ease the payment process for C.O.D. payments because the customer can prepare the payment in advance of arrival of the courier, by receipt of an e-mail that contains the billing and shipping information. A shipment could be held for many days when the payment was not ready at the delivery.

Moreover, since the system communicates with the credit card payment systems, the time required to prepare a shipment can be saved if the customer's credit card is not valid.

In one aspect, the present invention is directed to program code stored on a media that automates the process of arranging delivery for a shipment of goods to a customer, wherein said code, when executed by a processor, causes the processor to:

gather shipping information from a database;

accept user input, including shipment weight;

query one or more couriers' Web sites for shipping costs;

place an electronic shipping order at a first courier's Web site from the one or more queried couriers' Web sites, wherein said order includes an invoice number, the shipping information and the shipment weight; and

store shipping order information in the database, wherein said order information includes a tracking hyperlink.

In another aspect of the present invention, said program code further causes the processor to generate a packing slip.

In another aspect of the present invention, said packing slip includes the invoice number.

In another aspect of the present invention, the shipping information includes a ship from address and a ship to address.

In another aspect of the present invention, said program code further causes the processor to query the customer's credit card provider for sufficient finds before placing the electronic shipping order.

In another aspect of the present invention, said program code further causes the processor to select the first courier's Web site based on a lowest offered shipping cost.

In another aspect of the present invention, said program code further causes the processor to print a shipping label.

In another aspect of the present invention, said program code further causes the processor to send an email to the customer, wherein said email includes the tracking hyperlink.

In another aspect of the present invention, said email includes a copy of an invoice.

In another aspect, the present invention is directed to a computer system for shipping goods to a customer, comprising:

one or more general purpose computers that execute instructions found in one or more software modules;

a database stored on said one or more computers, wherein said database comprises shipping information;

an accounting module that receives purchase orders, generates an invoice and places said shipping information in said database; and

a shipping module interfaced through the Internet to one or more couriers' Web sites, wherein said shipping module provides shipping information from said database to said Web sites, queries shipping costs from said Web sites, places an electronic shipping order, and stores information received from said Web sites in said database.

In another aspect of the present invention, said shipping module generates a packing slip.

In another aspect of the present invention, said packing slip includes an invoice number.

In another aspect of the present invention, the shipping information includes a ship from address and a ship to address.

In another aspect of the present invention, said shipping module places the electronic shipping order with a courier's Web site offering a lowest shipping cost.

In another aspect of the present invention, said shipping module queries the customer's credit card provider for sufficient funds before placing the electronic shipping order.

In another aspect of the present invention, said received information includes a tracking hyperlink.

In another aspect of the present invention, said shipping module sends an email to the customer, wherein said email includes the tracking hyperlink.

In another aspect of the present invention, said email includes a copy of the invoice.

In yet another aspect, the present invention is directed to a computer system for conducting an electronic transaction with one or more Web sites, said system comprising:

one or more general purpose computers that execute instructions found in one or more software modules;

a database stored on said one or more computers comprising information generated by a first software module;

a second software module that:

retrieves information from said database,

gathers information associated with said retrieved information from each of a plurality of Web sites,

selects a first Web site from said plurality based on information gathered from said plurality,

automatically conducts an electronic transaction with said first Web site, and

stores transaction information received from said first Web site in said database.

In another aspect of the present invention, said second software module selects the first Web site based on a lowest cost.

In another aspect of the present invention, said first and second software modules are a single module.

### BRIEF DESCRIPTION OF THE DRAWINGS

FIG. 1 is a block diagram illustrating a computer shipping system;

FIG. 2 is a chart that illustrates an exemplary database schema;

FIG. 3 is a flow chart illustrating a series of acts for interacting with Web sites on the Internet; and

FIG. 4 illustrates examples of recording media.

### DETAILED DESCRIPTION OF THE INVENTION

The present invention comprises a system for interfacing an accounting system with various courier's Web sites so that an electronic shipping transaction may be automatically placed. The system is preferably implemented as program code (one or more software modules) stored and executed by a processor (computer) that is interfaced to the Internet. The system preferably retrieves shipping information from a database created and maintained by an existing accounting software package, queries several shipping courier's Web sites to determine which site offers the lowest shipping cost, and places an electronic shipping order with the selected courier's Web site.

Additionally, the present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, or the like, with the various algorithms being implemented with any combination of data structures, objects, processes, routines or other programming elements. The system preferably incorporates proprietary ACCPAC accounting software, but could be interfaced with any software packages providing accounting functions such as SAP, MAXIMO, Peachtree or the like. The shipping computer code is preferably programmed in Visual dBASE and Visual Foxpro. The object code created can be executed by any computer having an Microsoft Windows 95 or higher operating system.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

System Architecture

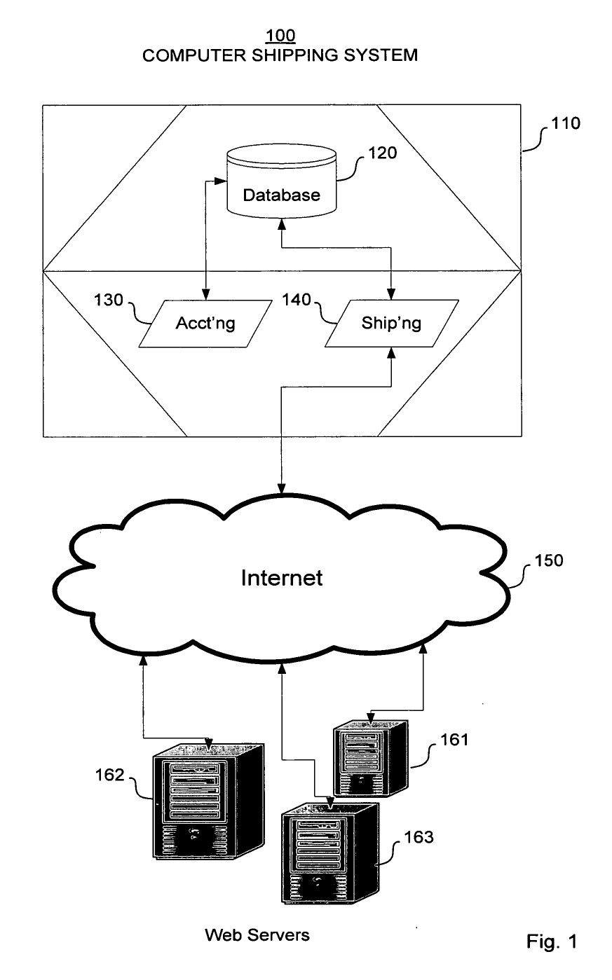

FIG. 1 is a block diagram that illustrates a computer shipping system that interfaces an existing accounting software package with shipping couriers' Web portals. As shown in FIG. 1 system 100 comprises a computer 110 comprising a database 120, an accounting software module 130 and a shipping module 140. Computer 110 interfaces through the Internet 150 to a number of Web servers 161-63.

In a preferred embodiment, accounting software module 130 creates and maintains database 120. Typically, data is input through the accounting software module 130 to enter an order. This information is stored in the database 120, which both the accounting software module 130 and the shipping module 140 are capable of accessing and updating. Because shipping module 140 and accounting software module 130 share database 120, when information is input into the database 120 through either module, the information is current when accessed through either module. Accordingly, data needs only to be entered once, and not twice, as in the prior art.

When an order is received from a customer, that customer's particular information can be accessed by shipping module 140 from database 120. From this accessed data, the order can be appropriately prepared for shipping. Database 120 is then updated with the information from the shipping module 140, and accounting software module 130 can generate an invoice and produce shipping stickers. There is no need for an individual to enter the information about the customer separately in two separate accounting and shipping systems.

The system of the present invention can also communicate with Web servers 161, 162 of couriers in order to determine shipping information and to make arrangements for shipment. It can also communicate with Web servers 163 of credit card companies to verify if the customer has sufficient funds to pay for the order. The Web servers 161-63 may comprise conventional hardware and software, to carry out the functions and operations typically accessed by shippers through a Web browser. Communications between computer 110 and Web servers 161-63 may be physically facilitated through cable or wireless links on which electronic signals can propagate, and may be embodied, for example, as (i) a dedicated wide area network (WAN), (ii) a telephone network, including the combination of local and long distance wire or wireless facilities and switches known as the public switched telephone network (“PSTN”), or (iii) the Internet 150.

The data and other information transmitted by Web servers 161-163 to computer 110 represents the information commonly provided by such servers in response to request for a Web page or a form POST method well known to those with skill in the art. Likewise, the data and other information transmitted by Web servers 161-63 to computer 110 represents Web pages provided in response to the requests made by computer 110. In addition, electronic transaction information may preferably be conveyed in COM objects which are called by shipping module 140 to generate shipping orders, payment requests and the like, as is well known in the art.

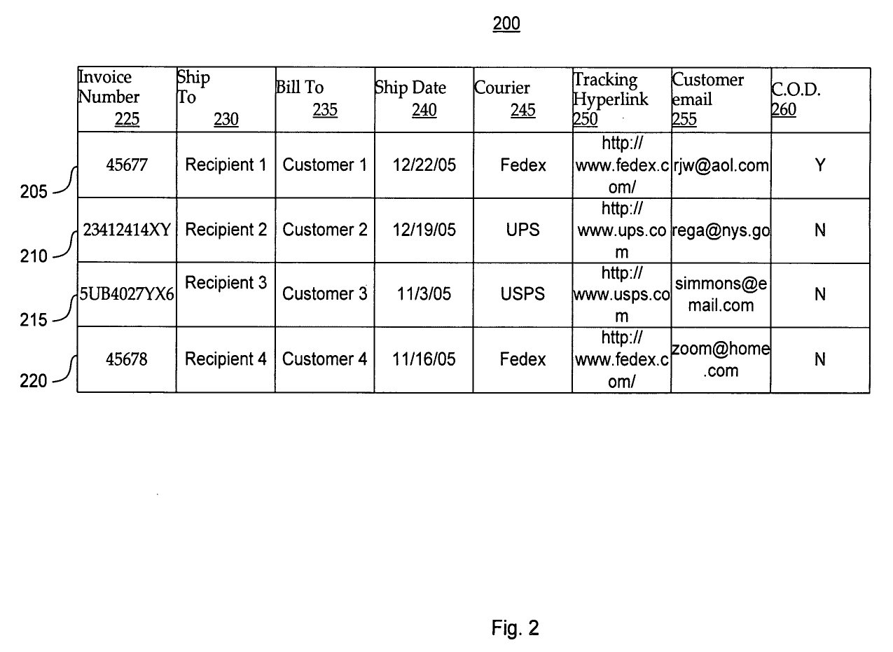

FIG. 2 is a chart that illustrates an exemplary database schema 200. Database 200 preferably stores information on orders for goods placed by customers. Database 200 maintains a plurality of records, such as records 205-220, each associated with a separate order placed by a customer. For each order identified by an invoice number in field 225, database 200 includes an indication of ship to and bill to information for the customer in fields 230 and 235 respectively. Such information may have been part of a preexisting accounting software package. In addition, database 200 preferably includes fields for the shipment date, courier's web site, a tracking link, customer's email address and whether the order should be paid for by C.O.D. in fields 240 through 260, respectively. Such fields may or may not have been part of the original accounting system database schema, but may be added as a modification of an original database to create database 200. Alternatively, existing fields in the database schema may be used to store this information.

System Operation

The following discussion describes the methods performed by the inventive system. To provide context, the operation of an exemplary, preferred embodiment of shipping module 140 is described.

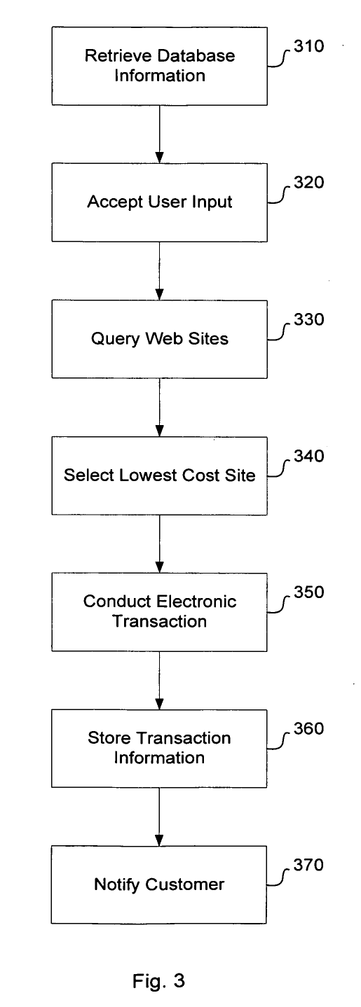

FIG. 3 illustrates activities implemented on system 110 running said shipping module program code 140. As shown in FIG. 3, in step 310, when an order is received from a customer, that customer's particular information is accessed by shipping module 140 from database 120, and then the order can be appropriately prepared for shipping.

In step 320, shipping module 140 provides the packer with a pick and pack slip. The packer will retrieve the ordered items and prepare one or more boxes for shipment. The packer will enter the number of boxes and their size and weight. This information is preferably verified and accepted by shipping module. Although this information is not illustrated in database schema 200, the shipment box identification and weight information is preferably stored in database 120.

In step 330, shipping module 140 determines the cost to ship the parcels from information provided by one or more couriers' rate tables and the parcel size, weight and ship to information preferably gathered from database 120. Because no additional data entry is necessary, keying input errors are eliminated. Furthermore, since this activity is automated, an amount of human labor is saved.

In step 340, shipping module 140 preferably selects the courier's Web site offering the lowest cost to ship the goods. In step 350, shipping module 140 conducts an electronic transaction with the selected courier Web site and provides the necessary information preferably stored in database 120 to complete the transaction. No human interaction is required or desired. In step 360, the resultant transaction information is stored in database 120. Such information includes a tracking hyperlink (URL) well-known in the art that is used to determine the status of the shipment.

Once the customer's shipping order is placed, in step 370 the invoice is posted by the accounting system module 130, and a copy of the invoice can be automatically sent to the customer by e-mail, preferably through simple mail transport protocol (SMTP), that is well-known in the art. The e-mail preferably includes the following information:

Date of shipment;

Name of the courier company;

Dynamic tracking hyperlink allowing a customer to track his order without having to enter the tracking number of his shipment;

C.O.D. (Cash On Delivery) amount so that customer can prepare payment in advance of delivery; and

A copy of the invoice, preferably attached as a PDF document.

In addition to sending an e-mail, the system can control peripheral equipment such as a printer to print a copy of the invoice.

The present invention may also be modified to integrate other systems such as, for example, Rate shopper and credit card payment (i.e., when the invoice is posted, the credit card payment is automatically performed).

In accordance with the above description, the present invention reduces the time required to produce the requisite shipment information (i.e., stickers, invoices, credit card slips, etc.) and thus the cost of shipping; increases customer satisfaction because of the ability to reduce the chances of incorrect information being input into the system as well as the occurrence of incorrect payments; reduces shipping delays; and provides the ability to track a shipment without entering the tracking number.

The present invention also reduces the amount of time spent on the phone by Customer Service because customers receive the most up-to-date information regarding their order via e-mail.

The present invention can also ease the payment process for C.O.D. payments because the customer can prepare the payment in advance of arrival of the courier due to receipt of the e-mail containing the billing and shipping information.

Moreover, since the system communicates with the credit card payment systems, the time and wastes required to prepare a shipment can be saved if the customer's credit card is not valid. Additionally, for customized goods, such as stationary printed with a customer's logo, the cost of creating such goods can be avoided if the customer's credit card provider will not pre-authorize the order payment amount. If the order payment amount is pre-authorized, a hold for the amount is placed with the credit card provider, and when the goods are shipped, the payment amount is charged.

Software on Media

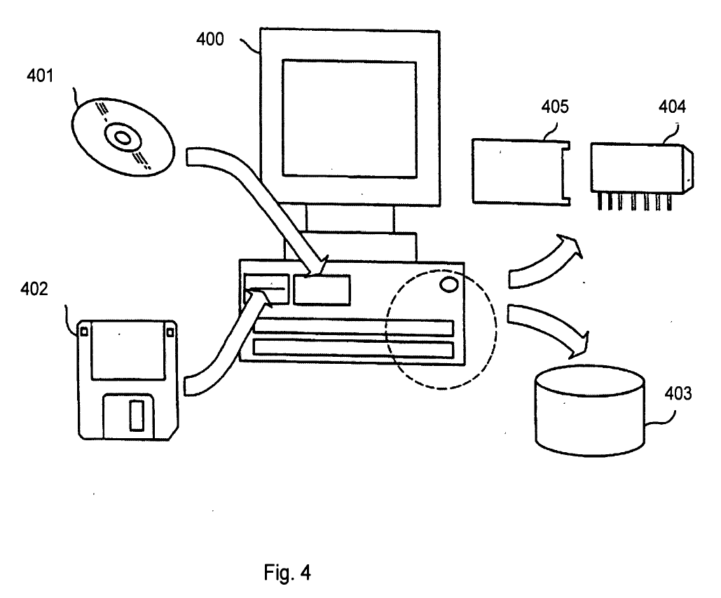

In the specification, the term “media” means any medium that can record data therein. FIG. 4 illustrates examples of recording media.

The term “media” includes, for instance, a disk shaped media for 401 such as CD-ROM (compact disc-read only memory), magneto optical disc or MO, digital video disc-read only memory or DVD-ROM, digital video disc-random access memory or DVD-RAM, a floppy disc 402, a memory chip 404 such as random access memory or RAM, read only memory or ROM, erasable programmable read only memory or E-PROM, electrical erasable programmable read only memory or EE-PROM, a rewriteable card-type read only memory 405 such as a smart card, a magnetic tape, a hard disc 403, and any other suitable means for storing a program therein.

A recording media storing a program for accomplishing the above mentioned apparatus maybe accomplished by programming functions of the above mentioned apparatuses with a programming language readable by a computer 400 or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer processing device 400, any suitable device for performing computations in accordance with a computer program may be used. Examples of such devices include a personal computer, a laptop computer, a microprocessor, a programmable logic device, or an application specific integrated circuit.

In accordance with the foregoing description, the present invention provides the following advantages:

Reduction in the time required to enter the same information on separate systems.

Reduction in the number of steps required to produce an invoice and shipping stickers.

Reduction in the number of mistakes due to manual work (i.e., reading of information written by hand on paper, data entry on different accounting and shipping systems.

Reduction in the time a person is required to spend between different departments that require the sharing of information (i.e., packing, shipping, and invoicing departments).

Reduction in the number of documents exchanged between departments.

Reduction in the time needed to look for documents and to match invoices and shipping stickers and boxes.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

I claim:

1. Program code stored on a media that automates the process of arranging delivery for a shipment of goods to a customer, wherein said code, when executed by a processor, causes the processor to:
gather shipping information from a database;
accept user input, including shipment weight;
query one or more couriers' Web sites for shipping costs;
place an electronic shipping order at a first courier's Web site from the one or more queried couriers' Web sites, wherein said order includes an invoice number, the shipping information and the shipment weight; and
store shipping order information in the database, wherein said order information includes a tracking hyperlink.

2. The program code of claim 1, which further causes the processor to generate a packing slip.

3. The program code of claim 2, wherein said packing slip includes the invoice number.

4. The program code of claim 1, wherein the shipping information includes a ship from address and a ship to address.

5. The program code of claim 1, which further causes the processor to query the customer's credit card provider for sufficient funds before placing the electronic shipping order.

6. The program code of claim 1, which further causes the processor to select the first courier's Web site based on a lowest offered shipping cost.

7. The program code of claim 1, which further causes the processor to print a shipping label.

8. The program code of claim 1, which further causes the processor to send an email to the customer, wherein said email includes the tracking hyperlink.

9. The program code of claim 1, wherein said email includes a copy of an invoice.

10. A computer system for shipping goods to a customer, comprising:
one or more general purpose computers that execute instructions found in one or more software modules;
a database stored on said one or more computers, wherein said database comprises shipping information;
an accounting module that receives purchase orders, generates an invoice and places said shipping information in said database; and
a shipping module interfaced through the Internet to one or more couriers' Web sites, wherein said shipping module provides shipping information from said database to said Web sites, queries shipping costs from said Web sites, places an electronic shipping order, and stores information received from said Web sites in said database.

11. The system of claim 10, wherein said shipping module generates a packing slip.

12. The system of claim 11, wherein said packing slip includes an invoice number.

13. The system of claim 10, wherein the shipping information includes a ship from address and a ship to address.

14. The system of claim 10, wherein said shipping module places the electronic shipping order with a courier's Web site offering a lowest shipping cost.

15. The system of claim 10, wherein said shipping module queries the customer's credit card provider for sufficient funds before placing the electronic shipping order.

16. The system of claim 10, wherein said received information includes a tracking hyperlink.

17. The system of claim 16, wherein said shipping module sends an email to the customer, wherein said email includes the tracking hyperlink.

18. The system of claim 17, wherein said email includes a copy of the invoice.

19. A computer system for conducting an electronic transaction with one or more Web sites, said system comprising:
one or more general purpose computers that execute instructions found in one or more software modules;
a database stored on said one or more computers comprising information generated by a first software module;
a second software module that:
retrieves information from said database,
gathers information associated with said retrieved information from each of a plurality of Web sites,
selects a first Web site from said plurality based on information gathered from said plurality,
automatically conducts an electronic transaction with said first Web site, and
stores transaction information received from said first Web site in said database.

20. The system of claim 19, wherein said second software module selects the first Web site based on a lowest cost.

21. The system of claim 19, wherein said first and second software modules are a single module.
